(19) United States
(12) Patent Application Publication
(10) Pub. No.: US 2009/0081951 A1
(43) Pub. Date: Mar. 26, 2009

(54) TIME SYNCHRONIZATION IN WIRELESS AD HOC NETWORKS OF MEDICAL DEVICES AND SENSORS

(75) Inventors: Bozena Erdmann, Aachen (DE); David Sanchez Sanchez, Aachen (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 11/719,301

(22) PCT Filed: Nov. 4, 2005
(86) PCT No.: PCT/IB2005/053621

§ 371 Date: May 15, 2007

Related U.S. Application Data
(60) Provisional application No. 60/628,146, filed on Nov. 16, 2004.

(51) Int. Cl. H04B 7/00

(52) U.S. Cl. 455/41.2

(57) ABSTRACT

A short-range ad-hoc network (20) of wireless medical devices (22, 24, 26, 28) intercommunicating by a short-range wireless technology are synchronized with official date and time information provided by a time server (70) residing in a medical infrastructure network (32). A time-control device (28, 66) synchronizes its clock (60′, 60″) with the time server. A selected wireless medical device (22) of the wireless shortrange network (20) wirelessly connects with the time control device using the short-range wireless communication protocol and synchronizes a clock (60) of the selected wireless medical device with the clock of the time-control device. The latter wireless connecting and the synchronizing is repeated to synchronize the clocks of each wireless medical device of the short-range network.

The following relates to the medical arts. It finds particular application in time synchronization of wireless autonomous sensor networks, and will be described with particular reference thereto. More generally, it finds application in synchronizing wireless medical sensors and devices in hospitals and other medical facilities.

Wireless short-range ad hoc networks including a plurality of wireless sensor nodes and/or other wireless medical devices are increasingly being deployed for continuous health monitoring and care in hospitals. Such networks advantageously can operate autonomously, without the need for connection to the medical infrastructure network, thus enabling continuity of vital signs monitoring or other medical operations while the patient is moved to a new room, to a testing center, or so forth. In ad hoc networks, the wireless devices forming the network monitoring or treating a patient are wirelessly interconnected. Later, when the patient leaves, the wireless devices can be integrated into other ad hoc networks for other patients on an ad hoc basis.

Each sensor node or other component of the wireless short-range ad hoc network includes a low power, short-range wireless communication link, such as a Bluetooth or ZigBee link, for communicating with other devices of the network. In some approaches, one of the nodes of the wireless short-range ad hoc network serves as a control node that coordinates activities of the network. For example, the control node may collect, pre-process and store sensor readings from the sensor nodes of the network. In some approaches, the control node also includes long-range wireless networking capability (e.g. WLAN) enabling it to communicate with nearby wireless access points of a medical infrastructure network and/or other wireless medical devices. In such cases, the control node may provide wireless interfacing between the wireless short-range ad hoc network and servers, databases, computers or medical devices residing in the medical infrastructure network and/or other wireless medical devices connected to it.

One issue that arises in wireless short-range ad hoc networks is time synchronization of the constituent wireless medical devices. Time synchronization is an essential element for any organization that relies on an information technology system. The reason for this is that these systems all have clocks that are the source of time for files or operations they handle. Without time synchronization, time on these systems varies with respect to each other or the official time and this can cause data to be lost, processes to fail, security to be compromised, an increase in legal exposure.

Certain operations of the wireless short-range ad hoc network may be time-critical. For example, in interventional operations, the temporal order of operations can be important. In monitoring, sensor data recorded while the wireless short-range ad hoc network is operating autonomously should be logged with accurate date and time information so that sensor data from different sensors can be reliably compared. Further, activity logs for control actions (e.g. changes of medicine dosing) may be collected for audit purposes. Still further, communication security may rely on time synchronization. For example, messages can be time-stamped for replay protection.

Due to the use of batteries or other on-board electrical power sources, the maintenance of time-clock synchronization cannot be guaranteed. The battery or other on-board power source may deplete, causing a re-setting of the internal clock of the node to a default value, such as to Jan. 1, 1980, at 12:00 a.m.

Furthermore, as each wireless medical device of the wireless short-range ad hoc network operates independently, there is the potential for drift of the internal clocks of the various devices. Electrical glitches due to nearby high-power equipment or other causes can also result in the internal clock being reset or corrupted, producing incorrect time values for the wireless medical device suffering the glitch. Because the wireless short-range ad hoc network must be created, configured, extended and dissolved in ad-hoc manner, seamlessly and easily, at best in self-organizing manner; repeated synchronization of every single node by medical personnel is impossible.

The following contemplates improved apparatuses and methods that overcome the aforementioned limitations and others.

According to one aspect, a method is provided for synchronizing wireless medical devices of a wireless short-range network with a time server of a medical network. The devices of the wireless short-range network intercommunicate by a short-range wireless communication protocol. A clock of a time-control device is synchronized with the time server. A selected wireless medical device of the wireless short-range network uses the short-range wireless communication protocol to establish a short-range wireless connection with the time-control device. A clock of the selected wireless medical device is synchronized with the clock of the time-control device via the established short-range wireless connection. The wireless connecting and the synchronizing are repeated to synchronize the clocks of each wireless medical device of the short-range network.

According to another aspect, an apparatus is disclosed for synchronizing a wireless short-range network of wireless medical devices, configured to communicate with each other by a short-range wireless communication protocol, with a time server of a medical network. Time-control software is configured for installation on a time-control device. Time-update software is configured for installation on wireless medical devices of the short-range network. Execution of the time-control software by a processor of the time-control device and execution of the time-update software by a processor of a selected wireless medical device cooperatively implements a method including: (i) synchronizing a clock of the time-control device with the time server; (ii) causing the selected wireless medical device to wirelessly connect with the time-control device using the short-range wireless communication protocol to establish a short-range wireless connection, and (iii) synchronizing a clock of the selected wireless medical device with the clock of the time-control device via the established short-range wireless connection.

One advantage resides in time-synchronizing wireless medical devices of a wireless short-range ad hoc network in which most or all of the wireless medical devices lack a long-range wireless interface or any other means of connecting to medical infrastructure network where the time server resides.

Another advantage resides in providing time synchronization of the wireless medical devices of a wireless short-range ad hoc network at regular intervals.

Yet another advantage resides in providing automated time synchronization of the wireless medical devices of a wireless short-range ad hoc network without requiring user intervention.

Numerous additional advantages and benefits will become apparent to those of ordinary skill in the art upon reading the following detailed description.

The invention may take form in various components and arrangements of components, and in various process operations and arrangements of process operations. The drawings are only for the purpose of illustrating preferred embodiments and are not to be construed as limiting the invention.

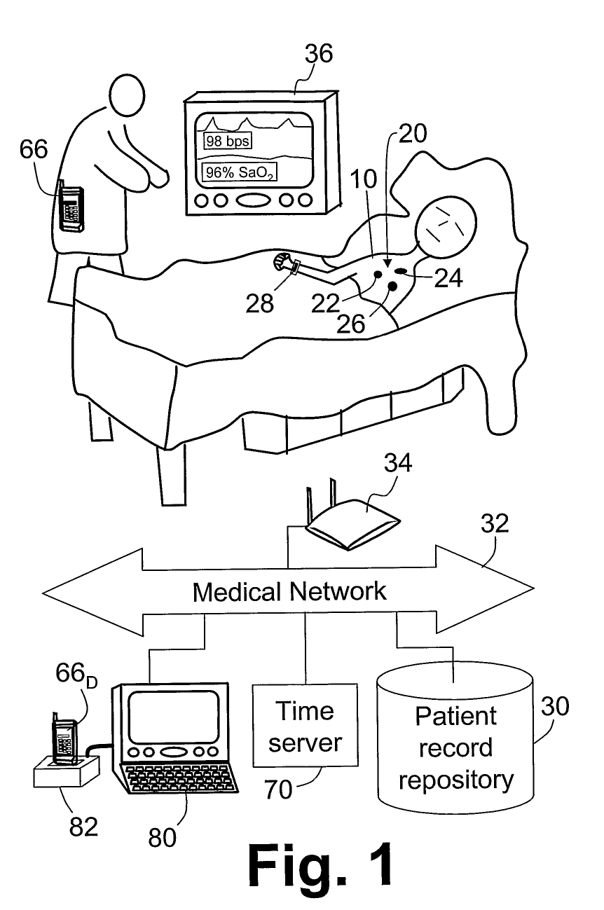

FIG. 1 illustrates an example of a wireless short-range ad hoc network of wireless medical devices operatively connected with a medical patient.

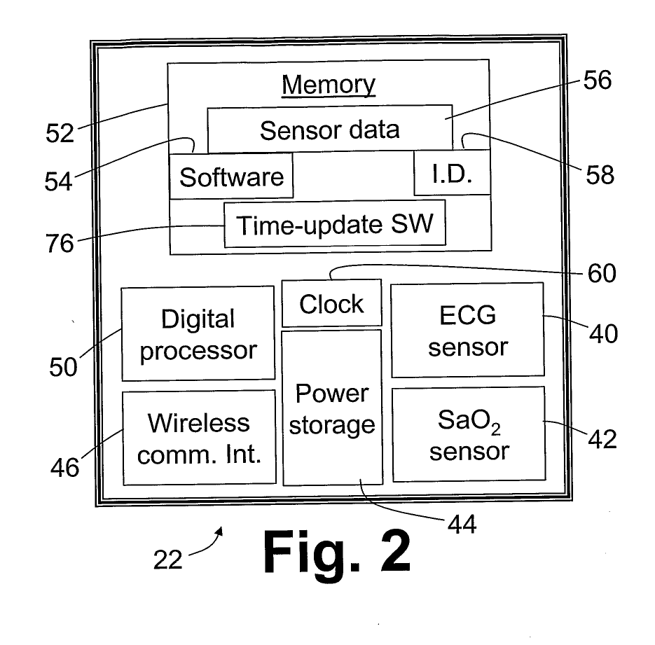

FIG. 2 diagrammatically illustrates one of the wireless nodes of the wireless short-range ad hoc network of FIG. 1.

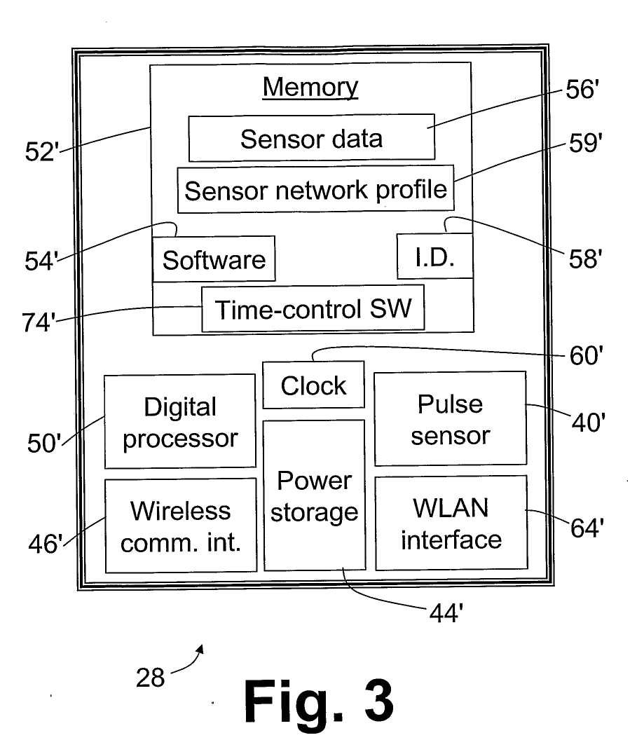

FIG. 3 diagrammatically illustrates the optional time control node of the wireless short-range ad hoc network of FIG. 1.

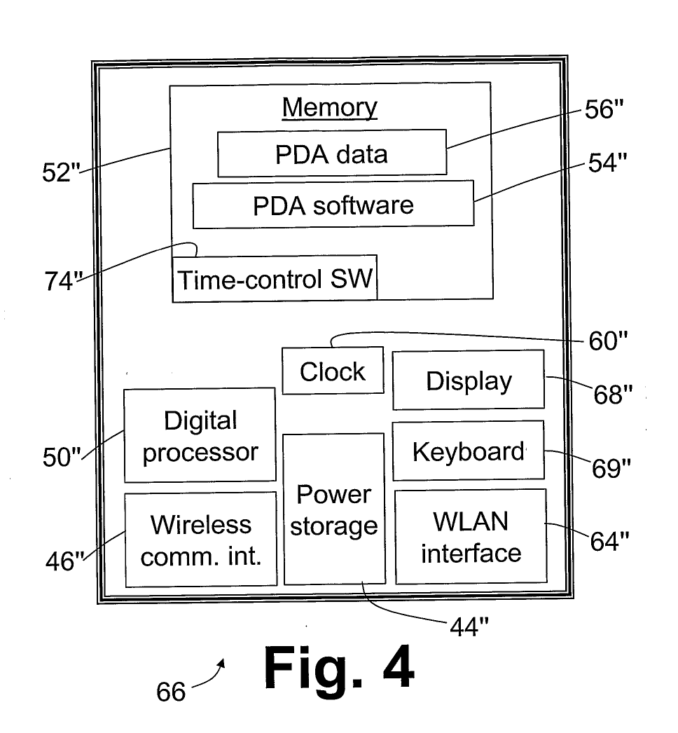

FIG. 4 diagrammatically illustrates a wireless personal electronic device optionally used in time-synchronizing the wireless short-range network of FIG. 1.

With reference to FIG. 1, a patient 10 is monitored by a wireless short-range ad hoc network 20 of wireless medical devices 22, 24, 26, 28. In the illustrated embodiment, the wireless medical devices 22, 24, 26 are wireless sensor nodes, while the wireless medical device 28 is an optional time control node worn by the patient 10 on a wristband. The time control node 28 provides centralized control for the short-range ad hoc network 20. More generally, the wireless short-range ad hoc network 20 can include substantially any number of any type of wireless medical devices, and optionally does not include a central control node such as the time control node 28. In the illustrated embodiment the sensor nodes 22, 24, 26 communicate sensor data to the time control node 28, which pre-processes and collects the sensor data, making it locally available and optionally transmits the collected sensor data to patient record repository 30 via a medical network 32, such as a local area network (LAN), accessed via a wireless access point 34. The collected sensor data may include, for example, electrocardiographic (ECG) data, blood oxygen saturation (SaO₂) data, heart rate, respiratory rate, respiratory cycle, blood pressure, brain waves, or so forth. The collected sensor data is suitably displayed on a wireless vital signs monitor 36 optionally included as another wireless medical device of the short-range ad hoc network 20, or is otherwise used to monitor the patient 10, to diagnose a medical problem of the patient 10, or so forth.

With continuing reference to FIG. 1 and with further reference to FIG. 2 which diagrammatically shows the illustrative wireless sensor node 22, each sensor node 22, 24, 26 includes one or more sensors, such as the ECG sensor 40 and SaO₂ sensor 42, and further includes a power supply 44 and a short-range wireless communication interface 46. The power supply 44 can be a rechargeable battery, storage capacitor, or other rechargeable power source, or can be a disposable battery. The wireless communication interface 46 employs a low power, short-range wireless technology having a range typically not extending substantially beyond the immediate vicinity of the patient 10. The sensor node 22 further includes a digital processor 50 and a non-volatile memory 52 having a portion allocated for storing software 54 that is executable by the digital processor 50, a portion 56 allocated for storing sensor data, and a portion allocated for storing a unique node identifier 58 used for addressing the sensor node 22 during wireless communications. Still further, the sensor node 22 includes an internal time-clock 60 used for time stamping collected sensor data or for other timing purposes.

With reference to FIG. 3, the optional time control node 28 similarly includes one or more optional sensors, such as the illustrated optional pulse sensor 40′, a power supply 44′, a short-range wireless communication interface 46′, a digital processor 50′, and a memory 52′. The memory 52′ has a portion allocated for storing software 54′ that is executable by the processor 50′, a portion 56′ allocated for storing sensor data (including sensor data from the optional sensor 40′ and sensor data wirelessly collected from the sensor nodes 22, 24, 26), and a node identifier 58′. The time control node 28 includes an internal clock 60′, and optionally also includes a long-range wireless communication interface 64′, such as a WLAN interface, used for communicating with the wireless access point 34 of the LAN 32. In some implementations, the time control node 28 uses the long-range wireless communication interface 64′ to connect to other wireless medical devices.

The WLAN interface 64′ of the time control node 28 enables the wireless short-range network 20 to connect with the LAN 32 which includes a time server 70. In some embodiments, however, the wireless short-range ad hoc network includes no devices having a WLAN interface. For example, the wireless short-range ad hoc network 20 with the time control node 28 omitted constitutes one such embodiment. In some embodiments, the medical environment may entirely lack a long-range wireless technology (like LAN 32 of wireless access points 34)—for example due to cost reasons. In such environments, wireless communication is built of clustered ad-hoc networks around the patient and a separated wired infrastructure network with servers and other computers. In other cases, the long-range network may be available, but its coverage is not sufficient to connect to each and every short-range network 20. In yet other cases, hospital network policy may not allow the time control node 28 to connect from the short-range network 20 with the LAN via the long-range interface 64′, e.g. to assure security of the medical infrastructure networks 32, to assure performance of the wireless access points 34 or to limit power consumption in the control devices 28.

In these embodiments, the wireless short-range ad hoc network cannot directly communicate with the LAN 32 to perform time synchronization. Instead, a wireless personal electronic device 66 is used to wirelessly access the short-range ad hoc network. The illustrated wireless personal electronic device 66 is a personal data assistant (PDA) carried by a doctor or other medical person. However, the wireless personal electronic device may be a cellular telephone, a pager, or so forth.

With reference to FIG. 4, the illustrated PDA 66 includes components typical for wireless electronic devices such as a power supply 44″, a digital processor 50″, and memory 52″. The memory 52″ has a portion allocated for storing PDA software 54″ configured to perform typical PDA tasks (such as maintaining a scheduling calendar, maintaining an address book, sending and receiving email, and so forth), and has a portion 56″ allocated for storing PDA data related to such PDA tasks. The PDA 66 further includes an internal clock 60″, and other components that are specific to the PDA device, such as a display 68″ and a keyboard 69″. Still further, the PDA 66 optionally includes a wireless communication interface 46″ employing a Bluetooth, ZigBee, or other short-range wireless technology compatible with the wireless communication interfaces 46, 46′. Optionally, the PDA 66 also includes a WLAN interface 64″ employing an IEEE 802.11 protocol or other WLAN protocol compatible with the wireless access point 34 and/or with the WLAN interface 64′ of time control device 28.

The wireless interfaces 46, 46′, 46″ employ a low power, short-range wireless technology and associated communication protocols such as defined by the IEEE 802.15.1 Standard (also sometimes called Bluetooth), the IEEE 802.15.3 Standard, the 802.15.4 Standard (also sometimes called ZigBee), or the like. The short-range wireless technology have maximum operating distances of typically less than ten meters; accordingly, the wireless medical devices of the wireless short-range ad hoc network should be proximate to one another, such as in the same patient room or attached to the same patient. The wireless interfaces 46 are used by the wireless medical devices 22, 24, 26 of the wireless short-range ad hoc network 20 to intercommunicate amongst one another.

The optional wireless interfaces 64′, 64″ employ a long-range wireless technology and associated communication protocols such as defined by the IEEE 802.11a, b or g Standards (also called WLAN) or the like. These long-range wireless technologies typically have maximum operating distances of several tens or hundreds of meters; accordingly higher coverage is assured and higher distances can be spanned, so that for example wireless monitoring of patient vital signals is possible from nurses' room. WLAN is used herein as an example wireless technology for accessing the LAN 32; however, other wireless technologies can be used. Depending on the selected embodiment, such a WLAN interface may be used to connect to servers, databases, computers, medical mobile devices (e.g. personal electronic devices of clinicians): directly in ad hoc manner or indirectly through one WLAN access point or indirectly through the LAN. In the illustrated embodiment, the time control node 28 includes the WLAN interface 64′. The Bluetooth, ZigBee, or other short-range wireless protocols of the short-range wireless communication interfaces 46, 46′, 46″ are assumed to be not compatible with the long-range wireless protocols used by the interfaces 64′, 64″ and the medical LAN 32 wireless access points 34; accordingly, the wireless communication interfaces 46, 46′, 46″ cannot communicate with the LAN 32.

While the illustrated embodiment including a WLAN infrastructure component is typical, in some other embodiments, only the short-range Bluetooth, ZigBee or other short-range protocol may be available, and the medical network may be an entirely wired network.

The personal electronic device 66 of clinician, as well as wireless time control node 28 usually enable device configuration and bulk transfer of medical data (e.g. patient record) for establishment or dissolution of the wireless short-range ad hoc network. For these purposes, the device 28, 66 must provide a communication interface, either one of the wireless interfaces 46, 64 or an additional interface, either wireless (e.g. NFC, IR) or wired (e.g. Ethernet, USB, FireWire). The bulk data download can beneficially be combined with initial clock synchronization operations.

While the optional time control device 28 is part of the wireless short-range ad hoc network 20, the PDA 66 is not ordinarily included in the network 20. However, the short-range wireless communication interface 46″ of the PDA 66 can be used to temporarily wirelessly connect with the wireless medical devices 22, 24, 26 of the short-range ad hoc network 20, and a medical person can use the temporarily connected PDA 66 to read the stored sensor data, reconfigure the wireless short-range ad hoc network 20 by adding or removing wireless medical devices, control/change the settings of wireless medical devices or so forth. Similarly, the wireless interface 64″ of the PDA can be used to temporarily wirelessly connect with the time-control node 28 of the short-range ad hoc network 20. With reference to FIGS. 1, 2, and 3, the time server 70 provides a “universal”, official date and time to synchronize the medical communications infrastructure. The internal clocks 60 of the wireless medical devices 22, 24, 26 of the wireless short-range ad hoc network 20 should be synchronized with the time server 70. However, the wireless medical devices 22, 24, 26 do not include the communication capability needed to access the time server 70 via the LAN 32.

To address this problem, the internal clocks 60 of the devices 22, 24, 26 are synchronized with the internal clock 60′ of the time control device 28, or with the internal clock 60″ of the PDA 66, via the wireless short-range interfaces 46, 46′, 46″. In turn, the internal clock 60′ of the time control device 28 is synchronized with the time server 70 or with the internal clock 60″ of the PDA 66, and in turn the internal clock 60″ of the PDA 66, is synchronized with the time server 70. Various such synchronization options are available, and the best one is chosen depending on the presence of a time control node 28 in the wireless ad hoc network, the wireless capabilities of time control nodes 28, 66 and on the possibility of online access to a time server from the wireless ad hoc network 20.

To perform the synchronization, the time-sourcing devices 28, 66 include time-control software 74′, 74″ that controls the synchronization with the time server 70 and the sending of the time information to the devices 22, 24, 26. Similarly, the devices 22, 24, 26 (and the optional wireless monitor 36 if it is included in the network and has an internal clock) each include time-update software 76 that receive the updated time information and updates the clocks 60 and can also trigger time-update, e.g. after power depletion.

In some embodiments, the wireless short-range ad hoc network 20 is completely autonomous, i.e. during its establishment and operation, the wireless short-range ad hoc network 20 does not need to rely on connection with medical infrastructure network, i.e. LAN 32. A time control device 28 is not necessarily present in the wireless short-range ad hoc network 20. The PDA 66, temporarily present in the wireless short-range ad hoc network 20 during network establishment and then removed except for occasional connection to read sensor data, to reconfigure the network 20, or so forth, distributes the time information to other devices 22, 24, 26 of the wireless short-range network 20 initially and in every subsequent connection to the wireless short-range ad hoc network 20.

In other embodiments, the wireless short-range ad hoc network 20 is completely autonomous except during its establishment, and the wireless short-range ad hoc network 20 does not connect with medical infrastructure network, i.e. LAN 32. Once the clock 64′ of the time control device 28 is configured for operation in wireless short-range ad hoc network 20 and initially synchronized with the time server 70, it distributes the time information to other devices 22, 24, 26 of the wireless short-range network 20 for the time of operation of this wireless short-range ad hoc network 20, without the need to re-connect to the infrastructure network 32 and time server 70.

The clock 60″ of the PDA 66 is suitably synchronized with the time server 70 when it is connected with the medical network 32. This connection can be a wireless connection, for example via the WLAN interface 64″ connecting with the wireless access point 34. Additionally or alternatively, a wired connection of the PDA 66 or patient-worn time-control device 28 with the medical network 32 can be established either directly or via another device connected with the network 32. For example, with reference to FIG. 1 a computer 80 in wired connection with the medical network 32 includes a PDA docking port 82 into which the PDA 66 can be inserted to establish a data transfer connection for transferring data between the PDA 66 and the computer 80. (The PDA 66 in the docked state is also shown in FIG. 1 labeled as PDA 66_{D}.). While docked, this wired connection with the medical network 32 via the computer 80 can be used by the time-control software 74″ to synchronize the PDA clock 60″ with the time server 70. Instead of using a wired data transfer connection via the docking port 82, in some embodiments the PDA 66 wirelessly “docks” with the computer 80 via a short-range Bluetooth or ZigBee connection or the like, and clock synchronization can occur while the PDA 66 is wirelessly docked.

In still yet other embodiments, more than one device including time-control software 74′, 74″ can be employed in the time synchronization process. For example, consider the wireless short-range network 20 including the time control node 28. If this wireless short-range ad hoc network 20 is out of range of any wireless access point 34 (for an extended period of time or permanently), or constant usage of WLAN interface 64′ of its time control node 28 is undesirable (e.g. for power-saving or performance reasons), it may be useful to perform synchronization via an intermediary time control device such as the PDA 66. The doctor's PDA 66 is often connected to the medical infrastructure network to transfer medical data (e.g. patient records) either wirelessly or in a wired manner such as via the PDA docking port 82; at the same time its clock can be synchronized with the time server 70. Further, as the doctor wanders through the hospital, the carried PDA 66 typically passes by numerous access points and can therefore be readily time-synched with the time server 70. Then, when the doctor visits the patient 10, the time control node 28 connects with the PDA 66 via the wireless communication interfaces 46′, 46″, and synchronizes its internal clock 60′ with the clock 60″ of the PDA 66. The nodes 22, 24, 26 are then synchronized with the clock 60′ of the time control node 28 as previously described. Optionally, the time control node 66 can actively trigger time synchronization on time control node 28.

In some embodiments, the wireless short-range ad hoc network 20 is completely autonomous, i.e. during its operation and establishment the wireless short-range ad hoc network 20 does not need to rely on connection with medical infrastructure network, i.e. LAN 32. In these embodiments, a temporary time control device such as the PDA 66 is present in the wireless short-range ad hoc network 20 during network establishment phase and occasionally for brief periods thereafter, such as when a clinician reads sensor data via the PDA 66. While connected to the short-range wireless network, the PDA 66 provides the time control device 28 of the wireless short-range network 20 with the time information. The time control device 28 initially (when the ad hoc short range network 20 is established) and regularly (when its clock 60′ is resynchronized) distributes the time information to other devices 22, 24, 26 of the wireless short-range network 20 for the time of operation of this wireless short-range ad hoc network 20, without the need to connect to the infrastructure network 32 and time server 70. In other completely autonomous networks that do not include the time control device 28 as a network node, the PDA 66 directly accesses the devices 22, 24, 26 and performs clock synchronization.

The clock synchronization can be unconditional, i.e. every connection to LAN 32 with time server 70 or to a time control device, e.g. PDA 66, triggers time-clock synchronization on a time control device 28, 66. Further, clock synchronization can be subject to hierarchical rules, e.g. time control device 28 can synchronize from PDA 66, but not the other way round. Yet further, clock synchronization can be subject to certain other conditions, e.g. time elapsed from last synchronization of the clock 60′ of time control device 28 or time elapsed from last direct synchronization of clock 60″ of PDA 66 with the time server 70.

Time-control software 74′ is installed on time control device 28, and similarly time-control software 74″ is installed on the PDA 66. Using the sensor node 22 and time control device 28 as an example, execution of the time-control software 74′ by the processor 50′ causes the short-range wireless communication interface 46′ of the time control device 28 to connect (if not yet connected) with the wireless communication interface 46 of the sensor node 22, and synchronize the clock 60 of the sensor node 22 with the clock 60′ of the time control node 28. This latter process is repeated for each of the wireless medical devices 22, 24, 26 in order to synchronize their internal clocks. The same procedure applies also for synchronizing wireless nodes 22, 24, 26 in the short-range ad hoc network 20 with the PDA 66 via short-range interface 46, 46″. The time synchronization message can also be sent in broadcast, thus updating clocks of all devices of the wireless short-range ad hoc network at the same time.

In the above-described procedure, the time synchronization procedure is initialized by the time control node 28, e.g. after joining the wireless short-range ad hoc network and/or each time 28 re-synchronized its clock 60′. The time synchronization procedure can also be triggered by wireless medical devices 22, 24, 26, e.g. each time they lose synchronization. Then the procedure changes to the following: Time-update software 76 is installed on each of the wireless medical devices 22, 24, 26, which do not include a WLAN interface. Using the sensor node 22 as an example, execution of the time-update software 76 by the processor 50 causes the wireless communication interface 46 of the sensor node 22 to connect with the wireless communication interface 46′ of the time control node 28, and synchronize the clock 60 of the sensor node 22 with the clock 60′ of the time control node 28.

In some embodiments, synchronization of clock 60′ of the time control node 28 is performed when the time control node 28 has established wireless connection over WLAN interface 64′ with the PDA 66 or with the LAN 32 for other purposes, such as for the purpose of transferring recorded sensor data to the PDA 66 for diagnosis or to the patient record repository 30, respectively. Once the WLAN connection is established for the data transfer purpose, the time-control software 74′ is executed by the processor 50′ to update the internal clock 60′. In other embodiments, the time control node 28 periodically wirelessly connects with the wireless access point 34 and performs the time synchronization.

With reference to FIGS. 1, 2, and 4, in embodiments in which none of the wireless medical devices of the wireless short-range ad hoc network include a WLAN interface (such an embodiment being, for example, the illustrated wireless short-range ad hoc network 20 with the time control node 28 omitted), the time-control function is performed by a wireless personal electronic device such as the illustrated PDA 66 which is temporarily connected with the network 20 for other purposes. The PDA 66 includes time-control software 74″ stored in the memory 52″. Execution of the time-control software 74″ by the processor 50″ causes the WLAN interface 64″ of the PDA 66 to wirelessly connect with the LAN 32, and synchronize the internal clock 60″ with the time server 70. The time-control software 74″ then causes the wireless communication interface 46″ of the PDA 66 to connect with the wireless communication interface 46 of the sensor node 22, and synchronizes the clock 60 of the sensor node 22 with the clock 60″ of the PDA 66. Connection is made in turn with each of the wireless medical devices 22, 24, 26 which do not include a WLAN interface in order to synchronize the internal clocks of the wireless short-range ad hoc network 20 with the time server 70. Similarly, time-update software 76 of the wireless sensor nodes 22, 24, 26 can trigger clock 60 synchronization, e.g. periodically or at selected times, such as when the node is first integrated into the wireless short-range ad hoc network 20, or after a temporary loss of electrical power. The synchronization processes are generally sufficiently fast so as to be transparent to the user of the wireless personal electronic device 66.

In some embodiments, time synchronization is used for security-related purposes, such as logging access control events, providing time-based message authentication, and so forth. Accordingly, in these embodiments, the WLAN connections and short-range wireless connections used in the time synchronization processes should be secured connections. In some embodiments, the synchronization is performed by constructing a synchronization message at the source device which contains at least: (i) a timedate stamp from an internal clock recently synchronized with the time server 70; and (ii) to protect the integrity of the timedate stamp, a non-time-based message authentication code, such as a nonce- or sequential numbers-based authentication code. Alternatively, if source and receiver have any means to previously synchronize loosely and securely their clocks, they can use a time-based authentication. In other embodiments, the synchronization message contains the timedate stamp in an encrypted form, and the encrypted synchronization message is decrypted at the destination.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A method for synchronizing wireless medical devices of a wireless short-range network with a time server of a medical network, the devices of the wireless short-range network intercommunicating by a short-range wireless communication protocol, the method comprising:
(i) synchronizing a clock of a time-control device with the time server;
(ii) wirelessly connecting a selected wireless medical device of the wireless short-range network with the time-control device using the short-range wireless communication protocol to establish a short-range wireless connection;
(iii) synchronizing a clock of the selected wireless medical device with the clock of the time-control device via the established short-range wireless connection; and
(iv) repeating the wireless connecting (ii) and the synchronizing (iii) to synchronize the clocks of each wireless medical device of the short-range network.

2. The method as set forth in claim 1, wherein the wireless connecting (ii) and the synchronizing (iii) occur independently of and after, but not necessarily immediately after, the synchronizing (i).

3. The method as set forth in claim 1, wherein the time-control device is a personal electronic device carried by a medical person and configured for communication using the short-range wireless communication protocol, the personal electronic device not ordinarily being a part of the wireless short-range network.

4. The method as set forth in claim 3, wherein the wireless connecting (ii) includes:
selecting the selected wireless medical device responsive to relative movement between the personal electronic device and the selected wireless medical device, causing the personal electronic device and the selected wireless medical device that got close enough to establish the wireless connecting (ii) via the short-range wireless communication protocol.

5. The method as set forth in claim 3, wherein the synchronizing (i) includes:
wirelessly connecting the personal electronic device with the medical network to form a wireless network connection; and
synchronizing the clock of the personal electronic device with the time server via the wireless network connection.

6. The method as set forth in claim 1, wherein the synchronizing (i) includes:
connecting the time-control device with another device connected with the medical network to form a wired or wireless data transfer connection; and
synchronizing the clock of the personal electronic device with the time server via the wired or wireless data transfer connection.

7. The method as set forth in claim 1, wherein the wireless connecting (ii) establishes a secured wireless connection.

8. The method as set forth in claim 1, wherein the medical network employs a wireless network protocol that is incompatible with the short-range wireless communication protocol, and the synchronizing (i) includes:
wirelessly connecting the time-control device with the medical network using the wireless network protocol to establish a wireless network connection; and
synchronizing the clock of the time-control device with the time server via the network connection.

9. The method as set forth in claim 8, wherein the wireless time-control device is a designated medical device of the short-range network, the wireless time-control device being configured for communication using both the short-range wireless communication protocol and the wireless network protocol.

10. The method as set forth in claim 1, wherein the wireless synchronizing (iii) includes:
constructing a synchronization message containing at least a timedate stamp derived from the clock of the time-control device and non-time-based message authentication content;
communicating the synchronization message to the selected wireless medical device via the established short-range wireless connection;
at the selected wireless medical device, authenticating the synchronization message based on the non-time-based message authentication content; and
updating the clock of the selected wireless medical device based on the timedate stamp conditional upon successful authenticating.

11. The method as set forth in claim 1, wherein the time-control device includes a plurality of time-control devices, and the synchronizing (i) includes:
synchronizing a clock of a first time-control device with the time server;
wirelessly connecting a second time-control device with the first time-control device to establish an intermediate connection; and
synchronizing a clock of the second time-control device with the first time-control device via the established intermediate connection;
wherein the wireless connecting (ii) connects the selected wireless medical device of the wireless short-range network with the second time-control device.

12. An apparatus for synchronizing a wireless short-range network of wireless medical devices, configured to communicate with each other by a short-range wireless communication protocol, with a time server of a medical network, the apparatus comprising:
time-control software configured for installation on a time-control device; and
time-update software configured for installation on wireless medical devices of the short-range network;
execution of the time-control software by a processor of the time-control device and execution of the time-update software by a processor of a selected wireless medical device cooperatively implementing a method including: (i) synchronizing a clock of the time-control device with the time server; (ii) causing the selected wireless medical device to wirelessly connect with the time-control device using the short-range wireless communication protocol to establish a short-range wireless connection, and (iii) synchronizing a clock of the selected wireless medical device with the clock of the time-control device via the established short-range wireless connection.

13. The apparatus as set forth in claim 12, wherein the time-control software is configured for installation on a personal electronic device carried by a medical person and configured for communication using the short-range wireless communication protocol, the personal electronic device not ordinarily being a part of the wireless short-range network.

14. The apparatus as set forth in claim 13, wherein the personal electronic device is selected from a group consisting of: (i) a cellular telephone, (ii) a pager, and (iii) a personal data assistant.

15. The apparatus as set forth in claim 13, wherein the synchronizing (i) includes:
connecting the personal electronic device with one of the medical network and another device connected with the medical network to form a wired or wireless data transfer connection; and
synchronizing the clock of the personal electronic device with the time server via the wired or wireless data transfer connection.

16. The apparatus as set forth in claim 12, wherein the time-update software is configured to be executed by the processor of the selected wireless medical device responsive to integration of the selected wireless medical device into the wireless short-range network.

17. The apparatus as set forth in claim 12, wherein the time-control software is configured for installation on a designated device of the short-range network.

18. The apparatus as set forth in claim 17, wherein the designated device further includes additional software, execution of the additional software by the processor of the designated device causing the designated device to (iv) wirelessly receive data from other wireless medical devices of the short-range network, (v) wirelessly connect with the medical network to establish a data transfer connection, and (vi) transfer said received data to an associated patient record repository via the data transfer connection.

19. The apparatus as set forth in claim 18, wherein the synchronizing (i) is performed via the data transfer connection.

20. The apparatus as set forth in claim 12, wherein the time-control software is configured for installation on a plurality of time-control devices, execution of the time-control software causing the first time-control device to synchronize a clock of the first time-control device with the time server, and causing a second one of the plurality of time-control devices to wirelessly connect with the first time-control device to establish an intermediate connection and to synchronize a clock of the second time-control device with the first time-control device via the established intermediate connection.

21. The apparatus as set forth in claim 12, wherein the time-update software is executed by the processor of the selected wireless medical device responsive to a temporary loss of electrical power.
